(19) United States
(12) Patent Application Publication
(10) Pub. No.: US 2025/0061305 A1
(43) Pub. Date: Feb. 20, 2025

(54) TRAINING METHOD FOR A DEEP LEARNING MODEL

(71) Applicant: BEIJING BAIDU NETCOM SCIENCE TECHNOLOGY CO., LTD., BEIJING (CN)

(72) Inventors: Shuohuan WANG, Beijing (CN); Junyuan SHANG, BEIJING (CN); Yinqi YANG, BEIJING (CN); Guoxia WANG, BEIJING (CN); Linhao ZHANG, BEIJING (CN); Yu SUN, BEIJING (CN); Hua WU, BEIJING (CN); Haifeng WANG, BEIJING (CN)

(73) Assignee: BEIJING BAIDU NETCOM SCIENCE TECHNOLOGY CO., LTD., BEIJING (CN)

(21) Appl. No.: 18/936,686

(22) Filed: Nov. 4, 2024

(30) Foreign Application Priority Data
Dec. 20, 2023 (CN) 202311766496.9

(51) Int. Cl. G06N 3/043; G06N 3/045; G06N 3/0985

(52) U.S. Cl. CPC G06N 3/043; G06N 3/045; G06N 3/0985

(57) ABSTRACT

A training method, an inference method, a device, an apparatus, and a medium for a deep learning model are provided. A first model includes a plurality of first parameters, a second model comprises a plurality of second parameters, which is initialized to parameter values of a plurality of target parameters selected from the plurality of first parameters. The training method includes: determining a target loss for both the first model and the second model; adjusting parameter values, including: in response to determining that the target loss indicates that the parameter values of at least part of the target parameters need to be adjusted, synchronously adjusting the parameter values of the corresponding second parameters; and in response to determining that the target loss indicates that the parameter values of at least part of the second parameters need to be adjusted, synchronously adjusting the parameter values of the corresponding target parameters.

### CROSS REFERENCE TO RELATED APPLICATION

This application claims priority to Chinese Patent Application No. 202311766496.9, filed on Dec. 20, 2023, the contents of which are hereby incorporated by reference in their entirety for all purposes.

### TECHNICAL FIELD

The present disclosure relates to the technical field of artificial intelligence, and in particular to the technical fields of machine learning, deep learning, and the like, and specifically to a training method for a deep learning model, an inference method for a deep learning model, a training apparatus for a deep learning model, an inference apparatus for a deep learning model, an electronic apparatus, a computer-readable storage medium, and a computer program product.

### BACKGROUND

Artificial intelligence is the discipline of the study of making computers simulate certain thinking processes and intelligent behaviors of a human being (such as learning, reasoning, thinking, planning, etc.), and there are both hardware-level and software-level technologies. The artificial intelligence hardware technologies generally include technologies such as sensors, special artificial intelligence chips, cloud computing, distributed storage, large data processing, etc.; The artificial intelligence software technologies mainly include natural language processing technology, computer vision technology, speech recognition technology, machine learning/deep learning, large data processing technology, knowledge graph technology and other major technological directions.

The methods described in this section are not necessarily methods that have been previously conceived or employed. Unless otherwise indicated, it should not be assumed that any method described in this section is considered to be the prior art only due to its inclusion in this section. Similarly, the problems mentioned in this section should not be assumed to be recognized in any prior art unless otherwise indicated.

### SUMMARY

The present disclosure provides a training method for a deep learning model, an inference method for a deep learning model, a training apparatus for a deep learning model, an inference apparatus for a deep learning model, an electronic apparatus, a computer-readable storage medium, and a computer program product.

According to an aspect of the present disclosure, there is provided a training method for a deep learning model, where a first deep learning model includes a plurality of first parameters, a second deep learning model includes a plurality of second parameters, a number of the plurality of second parameters is less than a number of the plurality of first parameters, the plurality of first parameters includes a plurality of target parameters corresponding to the plurality of the second parameters, where the plurality of the second parameters are initialized to parameter values of the plurality of target parameters, the training method includes: determining a target loss for both the first deep learning model and the second deep learning model; adjusting parameter values of the plurality of first parameters and parameter values of the plurality of second parameters based on the target loss to obtain a trained first deep learning model and a trained second deep learning model, comprising: in response to determining that the target loss indicates that the parameter values of at least part of the plurality of target parameters included in the first deep learning model need to be adjusted, synchronously adjusting parameter values of second parameters included in the second deep learning model, corresponds to the at least part of the target parameters; and in response to determining that the target loss indicates that the parameter values of at least part of the plurality of second parameters included in the second deep learning model need to be adjusted, synchronously adjusting parameter values of target parameters included in the first deep learning model corresponds to the at least part of the second parameters.

According to another aspect of the present disclosure, there is provided an inference method for a deep learning model, where a first deep learning model includes a plurality of first parameters, a second deep learning model includes a plurality of second parameters, a number of the plurality of second parameters is less than a number of the plurality of first parameters, the plurality of first parameters includes a plurality of target parameters corresponding to the plurality of the second parameters, where the plurality of the second parameters are initialized to parameter values of the plurality of target parameters, the first deep learning model and the second learning model are trained by performing training operations, the training operations includes: determining a target loss for both the first deep learning model and the second deep learning model; adjusting parameter values of the plurality of first parameters and parameter values of the plurality of second parameters based on the target loss to obtain a trained first deep learning model and a trained second deep learning model, comprising: in response to determining that the target loss indicates that the parameter values of at least part of the plurality of target parameters included in the first deep learning model need to be adjusted, synchronously adjusting parameter values of second parameters included in the second deep learning model corresponds to the at least part of the target parameters; and in response to determining that the target loss indicates that the parameter values of at least part of the plurality of second parameters included in the second deep learning model need to be adjusted, synchronously adjusting parameter values of target parameters included in the first deep learning model corresponds to the at least part of the second parameters. The inference method includes: generating a plurality of predicted tokens sequentially using the second deep learning model; generating confidence level for each predicted token of the plurality of predicted tokens based on the plurality of predicted tokens using the first deep learning model; and verifying the plurality of predicted tokens based on a generation sequence of the plurality of predicted tokens to obtain an inference result, comprising: in response to determining that the confidence level of a currently verified predicted token is lower than a preset threshold, generating a correction token at a position of the currently verified predicted token using the first deep learning model to replace the currently verified predicted token as verified predicted token; and in response to determining that a preset token generation condition is satisfied, regenerating predicted tokens sequentially from a next position of the correction token based on the correction token using the second deep learning model and generating a confidence level for each regenerated predicted token of the regenerated predicted tokens using the first deep learning model for verification; obtaining the inference result based on the verified predicted tokens.

According to another aspect of the present disclosure, there is provided a training apparatus for a deep learning model, where a first deep learning model includes a plurality of first parameters, a second deep learning model includes a plurality of second parameters, a number of the plurality of second parameters is less than a number of the plurality of first parameters, the plurality of first parameters includes a plurality of target parameters corresponding to the plurality of the second parameters, where the plurality of the second parameters are initialized to parameter values of the plurality of target parameters, and the training apparatus includes: a determination unit, configured to determine a target loss for both the first deep learning model and the second deep learning model; a parameter adjustment unit, configured to adjust parameter values of the plurality of first parameters and parameters values of the plurality of second parameters based on the target loss to obtain a trained first deep learning model and a trained second deep learning model, comprising: a first parameter adjustment subunit, configured to synchronously adjust, in response to determining that the target loss indicates that the parameter values of at least part of the plurality of target parameters included in the first deep learning model need to be adjusted, parameter values of second parameters included in the second deep learning model, corresponds to the at least part of the target parameters; and a second parameter adjustment subunit, configured to synchronously adjust, in response to determining that the target loss indicates that the parameter values of at least part of the plurality of second parameters included in the second deep learning model need to be adjusted, parameter values of target parameters included in the first deep learning model corresponds to the at least part of the second parameters.

According to another aspect of the present disclosure, there is provided an inference apparatus for a deep learning model, where a first deep learning model includes a plurality of first parameters, a second deep learning model includes a plurality of second parameters, a number of the plurality of second parameters is less than a number of the plurality of first parameters, the plurality of first parameters includes a plurality of target parameters corresponding to the plurality of the second parameters, where the plurality of the second parameters are initialized to parameter values of the plurality of target parameters, the first deep learning model and the second learning model are trained by a training apparatus, the training apparatus includes: a determination unit, configured to determine a target loss for both the first deep learning model and the second deep learning model; a parameter adjustment unit, configured to adjust parameter values of the plurality of first parameters and parameters values of the plurality of second parameters based on the target loss to obtain a trained first deep learning model and a trained second deep learning model, comprising: a first parameter adjustment subunit, configured to synchronously adjust, in response to determining that the target loss indicates that the parameter values of at least part of the plurality of target parameters included in the first deep learning model need to be adjusted, parameter values of second parameters included in the second deep learning model, corresponds to the at least part of the target parameters; and a second parameter adjustment subunit, configured to synchronously adjust, in response to determining that the target loss indicates that the parameter values of at least part of the plurality of second parameters included in the second deep learning model need to be adjusted, parameter values of target parameters included in the first deep learning model corresponds to the at least part of the second parameters. The inference apparatus includes: a first generation unit, configured to generate a plurality of predicted tokens sequentially using the second deep learning model; a second generation unit, configured to generate confidence level for each predicted token of the plurality of predicted tokens based on the plurality of predicted tokens using the first deep learning model; and a verification unit, configured to verify the plurality of predicted tokens based on a generation sequence of the plurality of predicted tokens to obtain an inference result, comprising: a replacement subunit, configured to generate, in response to determining that the confidence level of the currently verified predicted token is lower than a preset threshold, a correction token at a position of the currently verified predicted token using the first deep learning model to replace the currently verified predicted token as the verified predicted token; and a generation subunit, configured to regenerate, in response to determining that a preset token generation condition is satisfied, predicted tokens sequentially from the next position of the correction token based on the correction token using the second deep learning model and generate a confidence level for each regenerated predicted token of the regenerated predicted tokens using the first deep learning model for verification; an inference subunit, configured to obtain the inference result based on the verified predicted tokens.

According to another aspect of the present disclosure, there is provided an electronic apparatus, comprising: one or more processors; a memory storing one or more programs configured to be executed by the one or more processors, the one or more programs including instructions for: a deep learning model, where a first deep learning model includes a plurality of first parameters, a second deep learning model includes a plurality of second parameters, a number of the plurality of second parameters is less than a number of the plurality of first parameters, the plurality of first parameters includes a plurality of target parameters corresponding to the plurality of the second parameters, where the plurality of the second parameters are initialized to parameter values of the plurality of target parameters; determining a target loss for both the first deep learning model and the second deep learning model; adjusting parameter values of the plurality of first parameters and parameters values of the plurality of second parameters based on the target loss to obtain a trained first deep learning model and a trained second deep learning model, including: in response to determining that the target loss indicates that the parameter values of at least part of the plurality of target parameters included in the first deep learning model need to be adjusted, synchronously adjusting parameter values of second parameters included in the second deep learning model corresponds to the at least part of the target parameters; and in response to determining that the target loss indicates that the parameter values of at least part of the plurality of second parameters included in the second deep learning model need to be adjusted, synchronously adjust parameter values of target parameters included in the first deep learning model corresponds to the at least part of the second parameters.

According to another aspect of the present disclosure, there is provided a non-transitory computer-readable storage medium that stores computer instructions, where the computer instructions are used to cause the computer to execute the method described above.

According to another aspect of the present disclosure, there is provided a computer program product, including a computer program, where the computer program implements the method described above when executed by a processor.

According to one or more embodiments of the present disclosure, for the first deep learning model and the second deep learning model that is built based on part of the parameters of the first deep learning model, the present disclosure firstly determines the target loss of the two models, and determines the parameters of the respective parameter values, which need to be adjusted, of the two models based on the target loss, and then synchronously adjusts the parameter values of the corresponding parameters of the other model based on the corresponding relationships between the parameters of the two models, thereby enabling generation of a plurality of models of different magnitudes at one time to meet requirements of different scenarios, different performances, and different effect targets. In addition, the first deep learning model and the second deep learning model are trained as a whole, and during the training, knowledge and information may be transferred in both directions to accelerate the convergence of the models and to enable both models to obtain better prediction capabilities.

It should be understood that the content described in this section is not intended to identify key or important features of the embodiments of the present disclosure, nor is it intended to limit the scope of the present disclosure. Other features of the present disclosure will become readily understood from the following specification.

### BRIEF DESCRIPTION OF THE DRAWINGS

The drawings illustrate embodiments and constitutes a part of the specification and are used in conjunction with the textual description of the specification to explain the example implementations of the embodiments. The illustrated embodiments are for illustrative purposes only and do not limit the scope of the claims. Throughout the drawings, like reference numerals refer to similar but not necessarily identical elements.

FIG. 1 illustrates a schematic diagram of an example system in which various methods described herein may be implemented according to embodiments of the present disclosure;

FIG. 2 illustrates a flowchart of a training method for a deep learning model according to embodiments of the present disclosure;

FIG. 3 illustrates a schematic diagram of a first deep learning model and a second deep learning model according to embodiments of the present disclosure;

FIG. 4 illustrates a flowchart of a process of determining a target loss of a first deep learning model and a second deep learning model according to embodiments of the present disclosure;

FIG. 5 illustrates a flowchart of an inference method for a deep learning model according to embodiments of the present disclosure;

FIG. 6 illustrates structural a block diagram of a training apparatus for a deep learning model according to an embodiment of the present disclosure;

FIG. 7 illustrates a structural block diagram of an inference apparatus for a deep learning model according to embodiments of the present disclosure; and

FIG. 8 illustrates a structural block diagram of an example electronic apparatus that can be used to implement embodiments of the present disclosure.

### DETAILED DESCRIPTION OF THE EMBODIMENTS

The example embodiments of the present disclosure are described below in conjunction with the accompanying drawings, which include various details of the embodiments of the present disclosure to facilitate understanding and should be considered as examples only. Therefore, one of the ordinary skills in the art will recognize that various changes and modifications may be made to the embodiments described herein without departing from the scope of the present disclosure. Similarly, descriptions of well-known functions and structures are omitted in the following description for the purpose of clarity and conciseness.

In the present disclosure, unless otherwise specified, the terms “first”, “second” and the like are used to describe various elements and are not intended to limit the positional relationships, timing relationships, or importance relationships of these elements, and such terms are only used to distinguish one element from another. In some examples, a first element and a second element may refer to the same instance of the element, while in some cases they may also refer to different instances based on the description in the context.

The terms used in the descriptions of the various examples in this disclosure is for the purpose of describing specific examples only and is not intended to be limiting. Unless the context clearly indicates otherwise, if the number of elements is not specifically defined, the element may be one or more. In addition, the term “and/or” used in the present disclosure encompasses any one of the listed items and all the possible combinations thereof.

In related techniques, different deep learning models are trained separately, and the training efficiency is quite low.

To solve the above problem, for a first deep learning model and a second deep learning model that is built based on part of the parameters of the first deep learning model, the present disclosure firstly determines a target loss of the two models, and determines parameters of the respective parameter values, which need to be adjusted, of the two models based on the target loss, and then synchronously adjusts the parameter values of the corresponding parameters of the other model based on the corresponding relationships between the parameters of the two models, thereby enabling the generation of a plurality of models of different magnitudes at one time to meet requirements of different scenarios, different performances, and different effect targets. In addition, the first deep learning model and the second deep learning model are trained as a whole, and during the training, knowledge and information may be transferred in both directions to accelerate the convergence of the models and to enable both models to obtain better prediction capabilities.

Embodiments of the present disclosure will be described in detail below with reference to the accompanying drawings.

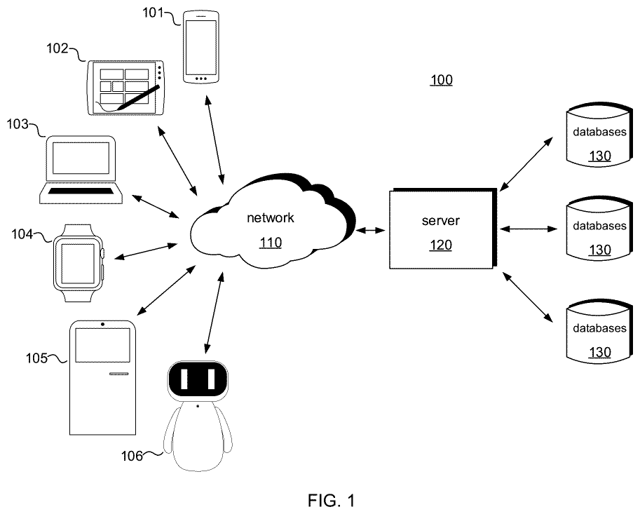

FIG. 1 illustrates a schematic diagram of an example system 100 in which various methods and apparatuses described herein may be implemented in accordance with embodiments of the present disclosure. Referring to FIG. 1, the system 100 includes one or more client apparatus 101, 102, 103, 104, 105, and 106, a server 120, and one or more communication networks 110 that couple the one or more client apparatuses to the server 120. The client apparatuses 101, 102, 103, 104, 105, and 106 may be configured to execute one or more applications.

In embodiments of the present disclosure, the server 120 may run one or more services or software applications that enable the execution of the method of present disclosure.

In some embodiments, the server 120 may further provide other services or software applications, which may include non-virtual environments and virtual environments. In some embodiments, these services may be provided as web-based services or cloud services, such as to users of the client apparatuses 101, 102, 103, 104, 105, and/or 106 under a Software as a Service (Saas) model.

In the configuration shown in FIG. 1, the server 120 may include one or more components that implement functions performed by the server 120. These components may include software components, hardware components, or combinations thereof that are executable by one or more processors. A user operating the client apparatuses 101, 102, 103, 104, 105, and/or 106 may sequentially utilize one or more client applications to interact with the server 120 to utilize the services provided by these components. It should be understood that a variety of different system configurations are possible, which may be different from the system 100. Therefore, FIG. 1 is an example of a system for implementing the various methods described herein and is not intended to be limiting.

The user may use the client apparatuses 101, 102, 103, 104, 105, and/or 106 to generate response data using a large model. The client apparatuses may provide interfaces that enable the user of the client apparatuses to interact with the client apparatuses. The client apparatuses may also output information to the user via the interfaces. Although FIG. 1 depicts only six client apparatuses, those skilled in the art will understand that the present disclosure may support any number of client apparatuses.

The client apparatuses 101, 102, 103, 104, 105, and/or 106 may include various types of computer apparatuses, for example, portable handheld apparatuses, general-purpose computers (such as personal computers and laptop computers), workstation computers, wearable apparatuses, smart screen apparatuses, self-service terminal apparatuses, service robots, gaming systems, thin clients, various messaging apparatuses, sensors or other sensing apparatuses, and the like. These computer apparatuses may run various types and versions of software applications and operating systems, such as Microsoft Windows, Apple IOS, Unix-like operating systems, Linux or Linux-like operating systems (e.g., Google Chrome OS); or include various mobile operating systems, such as Microsoft Windows Mobile OS, iOS, Windows Phone, Android. The portable handheld apparatuses may include cellular phones, smart phones, tablet computers, personal digital assistants (PDA), and the like. The wearable apparatuses may include head-mounted displays (such as smart glasses) and other apparatuses. The gaming systems may include various handheld gaming apparatuses, Internet-enabled gaming apparatuses, and the like. The client apparatuses can execute various different applications, such as various Internet related applications, communication applications (e.g., e-mail applications), Short Message Service (SMS) applications, and may use various communication protocols.

The network 110 may be any type of network well known to those skilled in the art, which may support data communication using any of a variety of available protocols (including but not limited to TCP/IP, SNA, IPX, etc.). By way of example only, one or more networks 110 may be a local area network (LAN), an Ethernet-based network, a token ring, a wide area network (WAN), an Internet, a virtual network, a virtual private network (VPN), an intranet, an external network, a blockchain network, a public switched telephone network (PSTN), an infrared network, a wireless network (e.g., Bluetooth, WiFi), and/or any combination of these and/or other networks.

The server 120 may include one or more general-purpose computers, a dedicated server computer (e.g., a PC (personal computer) server, a UNIX server, a mid-end server), a blade server, a mainframe computer, a server cluster, or any other suitable arrangement and/or combination. The server 120 may include one or more virtual machines running a virtual operating system, or other computing architectures involving virtualization (e.g., one or more flexible pools of a logical storage apparatus that may be virtualized to maintain virtual storage apparatuses of a server). In various embodiments, the server 120 may run one or more services or software applications that provide the functions described below.

The computing unit in the server 120 may run one or more operating systems including any of the operating systems described above and any commercially available server operating system. The server 120 may also run any of a variety of additional server applications and/or intermediate layer applications, including a HTTP server, an FTP server, a CGI server, a Java server, a database server, etc.

In some implementations, the server 120 may include one or more applications to analyze and merge data feeds and/or event updates received from the user of the client apparatuses 101, 102, 103, 104, 105, and/or 106. The server 120 may also include one or more applications to display the data feeds and/or the real-time events via one or more display apparatuses of the client apparatuses 101, 102, 103, 104, 105, and/or 106.

In some embodiments, the server 120 may be a server of a distributed system, or a server incorporating a blockchain. The server 120 may also be a cloud server, or an intelligent cloud computing server or an intelligent cloud host with an artificial intelligence technology. The cloud server is a host product in the cloud computing service system used to overcome the defects of high management difficulty and weak service expansibility which exist in the conventional physical host and Virtual Private Server (VPS) service.

The system 100 may also include one or more databases 130. In certain embodiments, these databases may be used to store data and other information. For example, one or more of the databases 130 may be used to store information such as audio files and video files. The databases 130 may reside in various locations. For example, the database used by the server 120 may be local to the server 120, or may be remote from the server 120 and may communicate with the server 120 via a network-based or dedicated connection. The database 130 may be of a different type. In some embodiments, the database used by the server 120 may be, for example, a relational database. One or more of these databases may store, update, and retrieve data to and from the database in response to a command.

In some embodiments, one or more of the databases 130 may also be used by an application to store application data. The database used by the application may be a different type of database, such as a key-value repository, an object repository, or a conventional repository supported by a file system.

The system 100 of FIG. 1 may be configured and operated in various ways to enable application of various methods and apparatus described according to the present disclosure.

According to an aspect of the present disclosure, there is provided a training method for a deep learning model. A first deep learning model includes a plurality of first parameters, a second deep learning model includes a plurality of second parameters, the plurality of second parameters is initialized to parameter values of a plurality of target parameters, corresponding to the plurality of second parameters, of the plurality of first parameters. The number of the plurality of second parameters is less than the number of the plurality of first parameters.

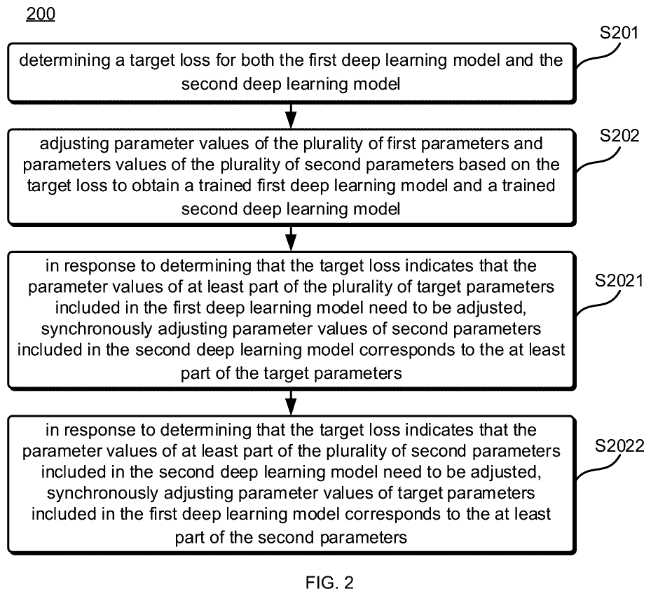

FIG. 2 illustrates a flowchart of a training method 200 for a deep learning model according to embodiments of the present disclosure. The method 200 includes: step S201, determining a target loss of the first deep learning model and the second deep learning model; step S202, adjusting parameter values of the plurality of first parameters and the plurality of second parameters based on the target loss to obtain a trained first deep learning model and a trained second deep learning model, comprising: step S2021, in response to determining that the target loss indicates that the parameter values of at least part of the plurality of target parameters included in the first deep learning model need to be adjusted, synchronously adjusting the parameter values of the second parameters, corresponding to the at least part of the target parameters, included in the second deep learning model; and step S2022, in response to determining that the target loss indicates that the parameter values of at least part of the plurality of second parameters included in the second deep learning model need to be adjusted, synchronously adjusting the parameter values of the target parameters, corresponding to the at least part of the second parameters, included in the first deep learning model.

Therefore, for the first deep learning model and the second deep learning model that is built based on part of the parameters of the first deep learning model, the method firstly determines the target loss of the two models, and determines the parameters of the respective parameter values, which need to be adjusted, of the two models based on the target loss, and then synchronously adjusts the parameter values of the corresponding parameters of the other model based on the corresponding relationships between the parameters of the two models, thereby enabling the generation of a plurality of models of different magnitudes at one time to meet requirements of different scenarios, different performances, and different effect targets. In addition, the first deep learning model and the second deep learning model are trained as a whole, and during the training, knowledge and information may be transferred in both directions to accelerate the convergence of the models and to enable both models to obtain better prediction capabilities.

In some embodiments, the first deep learning model and the second deep learning model may be based on various types of deep learning models, such as convolutional neural networks, recurrent neural networks, multilayer perceptron machines, fully connected networks, Transformer structures or Transformer-like structures (extension structures of various types of Transformer structures), or other types of deep learning models. The first deep learning model and the second deep learning model may be a complete end-to-end model or may be a part of a model for a specific task, which is not limited herein. Note that the first deep learning model and the second deep learning model belong to the same type of model.

In some embodiments, a first model architecture and a second model architecture may be used to describe the model architecture and model configuration information of the first deep learning model and the second deep learning model, which may include, for example, the number of layers included in the model, the number of intermediate dimensions of the layers of the model, and the like. The size of the second model architecture is smaller than that of the first model architecture, that is, the scale/size/number of parameters of the second deep learning model is less than that of the first deep learning model.

In some embodiments, a part of the plurality of first parameters (i.e., a plurality of target parameters) may be selected based on the number of the plurality of second parameters to build the second deep learning model. A plurality of target parameters with the same number as the plurality of second parameters may be selected from the plurality of first parameters, and the plurality of second parameters may be initialized to the parameter values of the plurality of target parameters. In other words, the parameter value of each of the second parameters of the initialized second deep learning model is the same as the parameter value of the target parameter, corresponding to the second parameter, of the first deep learning model. And during the subsequent training of the first deep learning model and the second deep learning model, the parameter values of the plurality of target parameters of the first deep learning model and the parameter values of the plurality of second parameters of the second deep learning model always remain the same, as will be described below.

In some embodiments, the plurality of target parameters may be obtained by performing random selection in the plurality of first parameters based on the number of the plurality of second parameters; or the selection in the plurality of first parameters may be performed by using some heuristic strategies, such as uniform distribution, or by using feature selection/feature engineering to obtain the plurality of target parameters that enable a better training result.

According to some embodiments, the first deep learning model may include a first layer quantity of first layers, the first layer quantity of first layers each may include a first intermediate dimension quantity of first intermediate dimensions. The second deep learning model may include a second layer quantity of second layers, the second layer quantity of second layers each may include a second intermediate dimension quantity of second intermediate dimensions. The second layer quantity of the second deep learning model may be less than the first layer quantity of the first deep learning model, and the second intermediate dimension quantities of the second layers of the second deep learning model may be less than the first intermediate dimension quantities of the first layers of the first deep learning model.

The plurality of target parameters may include first parameters in at least one target intermediate dimension of each of at least one target layer. The at least one target layer may be obtained by performing selection in the first layer quantity of first layers based on the second layer quantity, and the at least one target intermediate dimension may be obtained by performing selection in the first intermediate dimension quantity of first intermediate dimensions based on the second intermediate dimension quantity.

Therefore, in the foregoing manner, it is enabled that while the plurality of target parameters that satisfy the parameter quantity of the second deep learning model are selected from the plurality of first parameters included in the first deep learning model, the overall model architecture of the first deep learning model can be maintained as much as possible, such that over-concentration of the selected parameters is avoided and the prediction ability of the second deep learning model is improved.

According to some embodiments, the first deep learning model and the second deep learning model may be based on a Transformer structure or a Transformer-like structure. The first deep learning model may include a first hidden dimension quantity of first hidden dimensions, and the first layer quantity of first layers may each include a first attention head quantity of first attention heads. The second deep learning model may include a second hidden dimension quantity of second hidden dimensions, and the second layer quantity of second layers may each include a second attention head quantity of second attention heads.

The plurality of target parameters may include first parameters corresponding to a plurality of target hidden dimensions, and may include first parameters in at least one target attention head. The plurality of target hidden dimensions may be obtained by performing selection in the first hidden dimension quantity of first hidden dimensions based on the second hidden dimension quantity, and the at least one target attention head may be obtained by performing selection in the first attention head quantity of first attention heads based on the second attention head quantity.

Therefore, in the foregoing manner, it is enabled that while the plurality of target parameters that satisfy the parameter quantity of the second deep learning model are selected from the plurality of first parameters included in the first deep learning model, the overall model architecture of the first deep learning model which is based on a Transformer structure can be maintained as much as possible, such that over-concentration of the selected parameters are avoided and the prediction ability of the second deep learning model is improved.

In some embodiments, the first layer may be, for example, a Transformer layer, and the first intermediate dimension may be, for example, an Intermediate dimension in a Feed Forward Networks (FFN) in the Transformer layer.

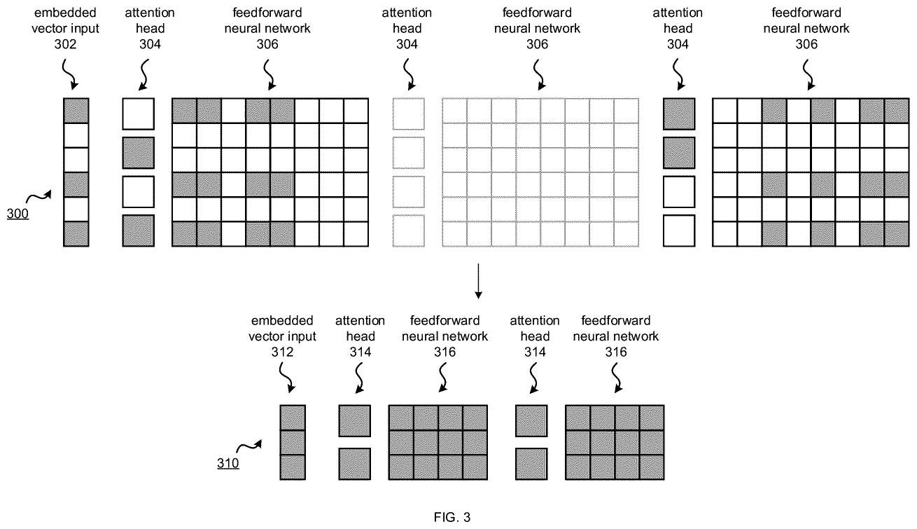

FIG. 3 illustrates a schematic diagram of a first deep learning model and a second deep learning model according to embodiments of the present disclosure. As shown in FIG. 3, the first deep learning model 300 includes an embedded vector input 302 with a hidden dimension of 6, and includes three Transformer layers, each Transformer layer includes a set of 4 attention heads 304 and a feedforward neural network 306 with an intermediate dimension of 8. The second deep learning model 310 includes an embedded vector input 312 with a hidden dimension of 3, and includes two Transformer layers, each Transformer layer includes a set of 2 attention heads 314 and a feedforward neural network 316 with an intermediate dimension of 4.

As can be seen from the figure, the plurality of target parameters selected from the plurality of first parameters includes first parameters in 1^{st}, 2^{nd}, 4^{th}, 5^{th} total of four intermediate dimensions of the first Transformer layer, and includes first parameters in 3^{rd}, 5^{th}, 7^{th}, 8^{th} total of four intermediate dimensions of the third Transformer layer. In addition, the plurality of target parameters includes first parameters corresponding to 1^{st}, 4^{th}, 6^{th} total of three hidden dimensions, includes first parameters in 2^{nd}, 4^{th}, total of two attention heads of the first Transformer layer, and includes first parameters in 1^{st}, 2^{nd} total of two attention heads of the third Transformer layer. The second deep learning model can be built based on these target parameters.

In some embodiments, the second model architecture (i.e., the number of layers, the number of intermediate dimensions, and the like which are included in the second deep learning model) may be determined based on the first model architecture and a preset ratio. In an example embodiment, the preset ratio may be 50%, meaning that the second layer quantity of the second deep learning model may be half of the first layer quantity of the first deep learning model, and the second intermediate dimension quantity of the second deep learning model may be half of the first intermediate dimension quantity of the first deep learning model. It will be appreciated that the second model architecture may also be determined based on a preset plurality of hyperparameter values, which are not limited herein.

According to some embodiments, the at least one target layer, the at least one target intermediate dimension, the plurality of target hidden dimensions, and/or the at least one target attention head may be obtained by random selection.

According to some embodiments, both the first deep learning model and the second deep learning model may be configured to perform at least one of the following tasks: a text processing task, an image processing task, and a speech processing task. The first deep learning model and the second deep learning model may be configured to perform the same task. Although the two models perform the same task, the two models may have different inference speeds and accuracies, because the two models have different parameter amounts, such that the requirements of different scenarios, different performances, and different effect targets may be met.

According to some embodiments, the first deep learning model may be a pre-trained large model. The pre-trained large model performs well in various text processing tasks, image processing tasks, and speech processing tasks, however, the reasoning cost of the pre-trained large model is high, and the deployment difficulty is high. If another “small” model is independently trained, knowledge that has been learned by the large model cannot be used, and the training process for the “small” model cannot further enhance the capability of the large model. Therefore, by obtaining a plurality of target parameters by performing selection in a pre-trained large model selecting, building a “small” model based on the plurality of target parameters, and training the large model and the “small” model as a whole, the knowledge and information can be transferred in both directions, the convergence of the model can be accelerated, and both models are enabled to obtain better prediction capabilities.

In some embodiments, one or more fixed mask matrices may be initialized to select the plurality of target parameters from the plurality of first parameters. The mask matrix includes only 0 and 1, with 0 representing that only the first deep learning model would be trained and 1 representing that both the first deep learning model and the second deep learning model would be trained. For a deep learning model based on the Transformer structure, the mask matrix may include a mask matrix for the hidden dimension, a mask matrix for the feed-forward neural network, a mask matrix for the attention head, and a mask matrix for the Transformer layer. It would be understood that for different types of deep learning models, the mask matrix may include mask matrices corresponding to different model structures, which is not limited herein.

In some embodiments, in step S201, the target loss of the first deep learning model and the second deep learning model in the training phase may be determined. It will be appreciated that the target loss may be calculated using various types of samples, various types of loss functions, and various types of training strategies, which is not limited herein.

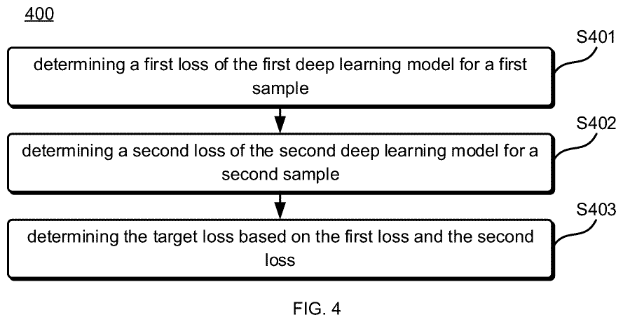

According to some embodiments, FIG. 4 illustrates a flowchart of a process 400 of determining a target loss of a first deep learning model and a second deep learning model according to embodiments of the present disclosure. The process 400 may be used to implement the step S201 of the method 200. The process 400 may include: step S401, determining a first loss of the first deep learning model for a first sample; step S402, determining a second loss of the second deep learning model for a second sample; and step S403, determining the target loss based on the first loss and the second loss.

Therefore, by determining the first loss and the second loss of the first deep learning model and the second deep learning model for the first sample and the second sample, respectively, then obtaining the target loss based on both the first loss and the second loss, such that the parameters of the first deep learning model and the second deep learning model can be adjusted at the same time in one training and the simultaneous training of the two models can be implemented.

In some embodiments, the first deep learning model and the second deep learning model may be trained using batch training, and both the first sample and the second sample may be batch data. In an example embodiment, the first deep learning model may be first trained with one batch of data (the first sample), and then the second deep learning model may be trained with one batch of data (the second sample), and an overall target loss may be obtained based on the two losses, such that the first deep learning model and the second deep learning model are jointly trained.

According to some embodiments, the first sample may be the same as the second sample. By making the first deep learning model and the second deep learning model to use completely identical training samples, the second deep learning model is enabled to learn the attention matrix and the probability distribution of the top layer of the first deep learning model, such that the training results of the second deep learning model and the first deep learning model fit better, the collaborative training of the two is accelerated, and the prediction capability of the two trained models is improved.

In some embodiments, in steps S401 and S402, a corresponding loss function may be selected as desired to obtain the first loss and the second loss. In step S403, the first loss and the second loss may be summed to obtain the target loss. In addition to the foregoing manner, the target loss may also be obtained based on the first loss and the second loss in other ways, which are not limited herein.

In some embodiments, in step S202, the parameters, whose parameter values need to be adjusted, of the plurality of first parameters and the plurality of second parameters may first be determined based on the target loss by backpropagation, and corresponding adjustment amounts may be determined. Further, in step S2021, in response to determining that the target loss indicates that the parameter values of at least a part of the plurality of target parameters included in the first deep learning model need to be adjusted, the parameter values of this part of the target parameters of the first deep learning model are adjusted based on the adjustment amounts determined for this part of the target parameters, and the parameter values of the second parameters of the second deep learning mode corresponding to this part of the target parameters are synchronously adjusted based on the same adjustment amounts. If the target loss indicates that the parameter value of certain first parameter other than the plurality of target parameters of the first deep learning model needs to be adjusted, the parameter value of this first parameter of the first deep learning model may be adjusted based only on the adjustment amount determined for this first parameter, whereas the parameters of the second deep learning model are not adjusted.

Similarly, in step S2022, in response to determining that the target loss indicates that the parameter values of at least a part of the plurality of second parameters included in the second deep learning model need to be adjusted, the parameter values of this part of the second parameters of the second deep learning model are adjusted based on the adjustment amounts determined for this part of the second parameters, and the parameter values of the target parameters (i.e. the first parameters), corresponding to this part of the second parameters, of the first deep learning mode are synchronously adjusted based on the same adjustment amounts.

In some embodiments, two adjustment amounts may be determined for the same parameter in the same training session (in the solutions to be described below, there may be a larger number of adjustment amounts), and the parameter value of the corresponding parameter in both models may be synchronously adjusted using one of the adjustment amounts, or the parameter value of the corresponding parameter in both models may be synchronously adjusted using the two adjustment amounts.

In some embodiments, the method 200 may be extended to train more models. The models to be trained may further include a third deep learning model. The third deep learning model includes a plurality of third parameters, the plurality of third parameters is initialized to parameter values of a plurality of shared parameters, corresponding to the plurality of third parameters, of the plurality of target parameters, where the number of the plurality of third parameters is less than the number of the plurality of second parameters. In other words, the plurality of target parameters corresponding to the plurality of second parameters is a subset of the plurality of first parameters, and the plurality of shared parameters corresponding to the plurality of third parameters is a subset of the plurality of target parameters. For the structure and operations of the third model, reference may be made to the description of the second model above.

In the training phase, the target loss of the three models may first be determined, and the parameter values of the parameters of each of the models are adjusted based on the target loss. Specifically, in response to determining that the target loss indicates that the parameter value of one of the parameters of one of the models needs to be adjusted, if the other two models include parameters corresponding to this parameter, the parameter values of the corresponding parameters are adjusted synchronously. In this way, three models of different magnitudes can be obtained.

It will be appreciated that with reference to the description above, the method 200 may further be extended to train four or more models, which will not be described herein. The method of the present disclosure can extend the number of trained models without increasing the training cost, because each model is trained in each round of training, and therefore extending the number of models would not increase the number of rounds of training.

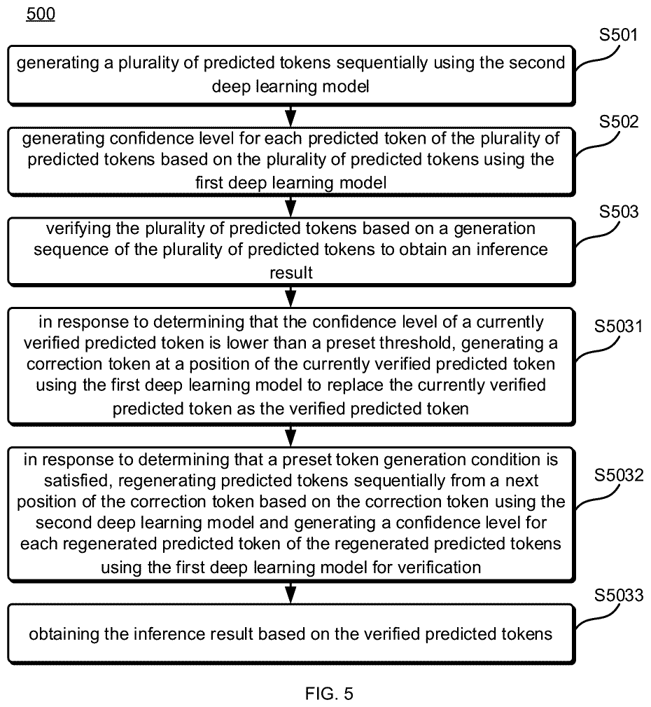

According to another aspect of the present disclosure, there is provided an inference method for a deep learning model. FIG. 5 illustrates a flowchart of an inference method 500 for a deep learning model according to embodiments of the present disclosure. The first deep learning model and the second deep learning model involved in the method 500 may be obtained by training using the training method 200 described above. The method 500 includes: step S501, generating a plurality of predicted tokens sequentially using the second deep learning model; step S502, generating respective confidence levels of the plurality of predicted tokens based on the plurality of predicted tokens using the first deep learning model; and step S503, verifying the plurality of predicted tokens based on the generation sequence of the plurality of predicted tokens to obtain an inference result, comprising: step S5031, in response to determining that the confidence level of the currently verified predicted token is lower than a preset threshold, generating a correction token at the position of the predicted token using the first deep learning model to replace the predicted token as a verified predicted token; step S5032, in response to determining that a preset token generation condition is met, regenerating predicted tokens sequentially from the next position of the correction token based on the correction token using the second deep learning model and generating the confidence levels of the regenerated predicted tokens using the first deep learning model for verification; and step S5033, obtaining the inference result based on the verified predicted tokens.

Deep learning model prediction typically includes two modes, one is a decoding mode, which requires token-by-token prediction and takes much longer. The other is a verification mode, that is, given multiple tokens that have been generated, the confidence level (i.e., a top-level probability distribution) of each token in this result can be obtained. Since the verification mode can process the entire generation sequence at one time, it takes significantly less time than the decoding mode. The present disclosure combines the decoding process of the second deep learning model with smaller size and the verification process of the first deep learning model with larger size, thereby high-quality results can be quickly obtained, and the performance and inference effects are further improved.

In some embodiments, in step S501, the plurality of predicted tokens may be generated sequentially using the second deep learning model in the decoding mode. Because the size of the second deep learning model is smaller, the prediction result sequence, i.e., the plurality of predicted tokens, can be obtained quickly even using the decoding mode.

In an example embodiment, a input token sequence may be input into the second deep learning model to obtain the first predicted token output by the model, and then the input token sequence and the first predicted token are input into the model again to obtain the second predicted token output by the model, and so on, until the model outputs [End] token representing the end or representing the output tokens have reached a preset number. It will be appreciated that the plurality of predicted tokens may be generated sequentially by using the second deep learning model in other ways besides the above way, which will not be limited herein.

In some embodiments, in step S502, the respective confidence levels of the plurality of predicted tokens may be directly generated based on the plurality of predicted tokens using the first deep learning model in the verification mode. Since the size of the first deep learning model is larger, it takes longer to obtain the prediction result sequence if the decoding mode is used; the top-level probability distributions corresponding to the plurality of predicted tokens generated by the second deep learning model can be obtained using the verification mode.

In some embodiments, in step S503, the plurality of predicted tokens may be verified based on the generation sequence of the plurality of predicted tokens, and corresponding operations may be performed based on the verification results.

In some embodiments, in step S5031, in response to determining that the confidence level of the currently verified predicted token is lower than a preset threshold, it is indicated that the first deep learning model with larger size considers that the currently verified predicted token is inaccurate. Therefore, the first deep learning model may be used in the decoding mode to generate a correction token at the position of the predicted token and to replace the predicted token generated by the second deep learning model. The correction token may be used as the verified predicted token for final generation of the inference result.

In an example embodiment, in response to determining that the confidence level of the currently verified predicted token is lower than a preset threshold, all the predicted tokens prior to the currently verified predicted token may be input into the first deep learning model to obtain a token of the current position generated by the first deep learning model, i.e., a correction token.

In some embodiments, in step S5032, in response to determining that a preset token generation condition is satisfied, the second deep learning model is used in the decoding mode to regenerate sequentially at least one predicted token from the next position of the correction token based on the correction token. And then, after the at least one predicted token has been generated or other abortion generation conditions are met, the first deep learning model is used in the verification mode to generate the confidence level of the at least one predicted token based on the regenerated at least one predicted token and then to verify the at least one predicted token. The above process may be repeated until all of the predicted tokens are verified.

According to some embodiments, the preset token generation condition may include that the number of generated tokens is less than a preset number. In other words, a preset number may be set, and predicted tokens may be generated and verified in units of the preset number, and after the completion of the verification, the predicted tokens may continue to be generated and verified in units of the preset number until the generation process is completed, for example, an [End] token with a high level of confidence has been generated.

Thereby, in the above manner, the upper limit of the length of the sequence of the predicted tokens being generated and verified can be controlled to avoid generating and verifying an excessively long predicted token sequence which would lead to performance degradation.

According to some embodiments, the preset token generation condition may include that the correction token indicates that the token generation has not ended. In an example embodiment, if the correction token is not an [End] token, then the preset generation condition is not met and the predicted tokens need be regenerated sequentially using the second deep learning model.

According to some embodiments, in step S503, the verifying the plurality of predicted tokens based on the generation sequence of the plurality of predicted tokens to obtain the inference result may further include: in response to determining that the confidence level of the currently verified predicted token is not lower than the preset threshold, retaining the predicted token as the verified predicted token.

Therefore, in the foregoing manner, it is enabled that the finally retained predicted tokens all have high confidence levels, thereby ensuring the quality of the generated inference result.

In some embodiments, in step S5033, contents corresponding to each of the verified predicted tokens, such as characters, images, speech, and the like, may be determined, and further the contents may be integrated to obtain the corresponding inference result.

Thereby, the predicted token sequence is generated based on the decoding mode using the second deep learning model with a smaller size, each of the generated predicted tokens is verified based on the verification mode using the first deep learning model with a larger size, the correction token of the current position is generated based on the decoding mode using the second deep learning model in the case of verification failure (e.g., is less than the confidence level), and the predicted tokens are regenerated one by one from the next position using the second deep learning model, thereby the high-quality inference result can be quickly obtained.

In some embodiments, models for inference further include a target deep learning model with a size larger than the first deep learning model, that is, the plurality of first parameters included in the first deep learning model is a subset of the plurality of parameters included in the target deep learning model. In step S5033, after obtaining the plurality of verification tokens that are verified by the first deep learning model, the confidence levels of the plurality of verification tokens may be generated using the target deep learning model, and the plurality of verification tokens may be further verified using these confidence levels. If certain verification token fails the verification of the target deep learning model, a new token may be generated by the target deep learning model at the position to replace the verification token, subsequent tokens may be regenerated after this token by the second deep learning model, thereby the subsequent tokens are reverified by the first deep learning model, and then the results that have been verified by the first deep school model may be reverified by the target deep learning model.

In some embodiments, the second deep learning model generates N1 predicted tokens each time, and the generated results are verified and regenerated by the second deep learning model. The results generated and verified by the first deep learning model and the second deep learning model may be considered as a whole, and each time when the first deep learning model and the second deep learning model complete N2 rounds of generation and verification, the obtained N1×N2 verified predicted tokens may be handed over to the target deep learning large model for verification and regeneration.

It will be appreciated that the foregoing way of generation and verification may further be extended to four or more models, and details are not described herein.

According to another aspect of the present disclosure, there is provided a training apparatus for a deep learning model. A first deep learning model includes a plurality of first parameters, a second deep learning model includes a plurality of second parameters, the plurality of second parameters is initialized to parameter values of a plurality of target parameters of the plurality of first parameters, the number of the plurality of second parameters is less than the number of the plurality of first parameters.

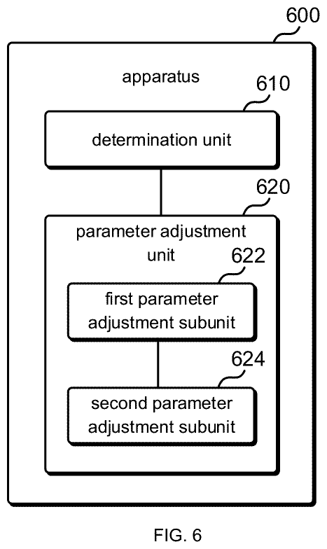

FIG. 6 illustrates a structural block diagram of a training apparatus 600 for a deep learning model according to embodiments of the present disclosure. The apparatus 600 includes: a determination unit 610, configured to determine a target loss of the first deep learning model and the second deep learning model; a parameter adjustment unit 620, configured to adjust parameter values of the plurality of first parameters and the plurality of second parameters based on the target loss to obtain a trained first deep learning model and a trained second deep learning model, comprising: a first parameter adjustment subunit 622, configured to synchronously adjust the parameter values of the second parameters, corresponding to the at least part of the target parameters, included in the second deep learning model in response to determining that the target loss indicates that the parameter values of at least part of the plurality of target parameters included in the first deep learning model need to be adjusted; and a second parameter adjustment subunit 624, configured to synchronously adjust the parameter values of the target parameters, corresponding to the at least part of the second parameters, included in the first deep learning model in response to determining that the target loss indicates that the parameter values of at least part of the plurality of second parameters included in the second deep learning model need to be adjusted.

It may be understood that the operations of the units 610-620 and the sub-units thereof in the apparatus 600 may refer to the descriptions of steps S201 to S202 and the sub-steps thereof in the method 200 above, and details are not described herein again.

According to some embodiments, the first deep learning model may include a first layer quantity of first layers, the first layer quantity of first layers each may include a first intermediate dimension quantity of first intermediate dimensions.

The second deep learning model may include a second layer quantity of second layers, the multiple second layers each may include a second intermediate dimension quantity of second intermediate dimensions. The second layer quantity may be less than the first layer quantity, and the second intermediate dimension quantity may be less than the first intermediate dimension quantity.

The plurality of target parameters may include first parameters in at least one target intermediate dimension of each of at least one target layer. The at least one target layer may be obtained by performing selection in the first layer quantity of first layers based on the second layer quantity, and the at least one target intermediate dimension may be obtained by performing selection in the first intermediate dimension quantity of first intermediate dimensions based on the second intermediate dimension quantity.

According to some embodiments, the first deep learning model and the second deep learning model may be based on a Transformer structure or a Transformer-like structure.

The first deep learning model may include a first hidden dimension quantity of first hidden dimensions, indicating that the first layer quantity of first layers may each include a first attention head quantity of first attention heads.

The second deep learning model may include a second hidden dimension quantity of second hidden dimensions, indicating that the second layer quantity of second layers may each include a second attention head quantity of second attention heads.

The plurality of target parameters may include first parameters corresponding to a plurality of target hidden dimensions, and may include first parameters in at least one target attention head. The plurality of target hidden dimensions may be obtained by performing selection in the first hidden dimension quantity of first hidden dimensions based on the second hidden dimension quantity, and the at least one target attention head may be obtained by performing selection in the first attention head quantity of first attention heads based on the second attention head quantity.

According to some embodiments, the at least one target layer, the at least one target intermediate dimension, the plurality of target hidden dimensions, and/or the at least one target attention head may be obtained by random selection.

According to some embodiments, both the first deep learning model and the second deep learning model may be configured to perform at least one of the following tasks: a text processing task, an image processing task, and a speech processing task.

According to some embodiments, the first deep learning model may be a pre-trained large model.

According to some embodiments, the determination unit may include: a first determination subunit, configured to determine a first loss of the first deep learning model for a first sample; a second determination subunit, configured to determine a second loss of the second deep learning model for a second sample; and a third determination subunit, configured to determine the target loss based on the first loss and the second loss.

According to some embodiments, the first sample may be the same as the second sample.

According to another aspect of the present disclosure, there is provided an inference apparatus for a deep learning model, where a first deep learning model and a second deep learning model may be obtained by training using the apparatus 600.

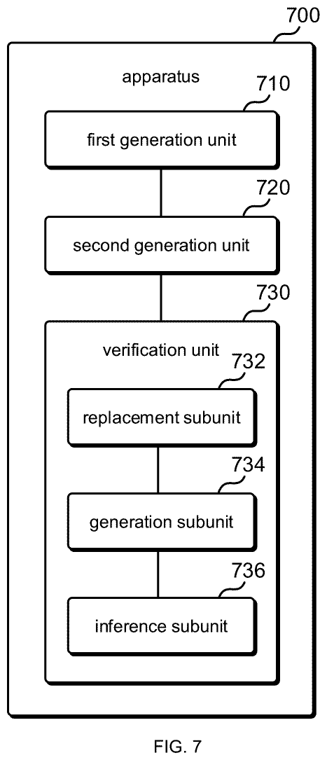

FIG. 7 illustrates a structural block diagram of an inference apparatus 700 for a deep learning model according to embodiments of the present disclosure. The apparatus 700 includes: a first generation unit 710, configured to generate a plurality of predicted tokens sequentially using the second deep learning model; a second generation unit 720, configured to generate respective confidence levels of the plurality of predicted tokens based on the plurality of predicted tokens using the first deep learning model; and a verification unit 730, configured to verify the plurality of predicted tokens based on the generation sequence of the plurality of predicted tokens to obtain an inference result, comprising: a replacement unit 732, configured to generate a correction token at the position of the predicted token using the first deep learning model to replace the predicted token as the verified predicted token in response to determining that the confidence level of the currently verified predicted token is lower than a preset threshold; a generation subunit 734, configured to regenerate predicted tokens sequentially from the next position of the correction token based on the correction token using the second deep learning model and generate the confidence levels of the regenerated predicted tokens using the first deep learning model for verification in response to determining that a preset token generation condition is met; and an inference subunit 736, configured to obtain the inference result based on the verified predicted tokens.

It may be understood that the operations of the units 710-730 and the sub-units thereof in the apparatus 700 may refer to the descriptions of steps S501 to S503 and the sub-steps thereof in the method 500 described above, and details are not described herein again.

According to some embodiments, the preset token generation condition may include that the number of generated tokens is less than a preset number.

According to some embodiments, the preset token generation condition may include that the correction token indicates that the token generation has not ended.

According to some embodiments, the verification unit 730 (not shown in the figures) may include: a retention subunit, configured to retain the predicted token as the verified predicted token in response to determining that the confidence level of the currently verified predicted token is not lower than the preset threshold.

In the technical solution of the present disclosure, the collection, storage, use, processing, transmission, provision, and disclosure of personal information of users involved are in compliance with relevant laws and regulations and do not violate public order and morals.

According to embodiments of the present disclosure, there is provided an electronical apparatus, a readable storage medium and a computer program product.

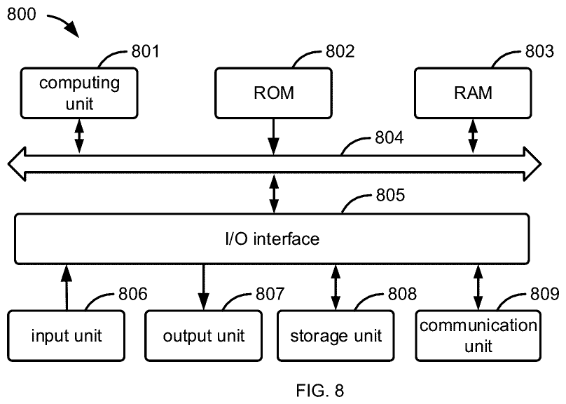

Referring to FIG. 8, a structural block diagram of an electronic apparatus 800 that may be a server or client of the present disclosure is now described, which is an example of a hardware apparatus that may be applied to aspects of the present disclosure. Electronic apparatuses are intended to represent various forms of digital electronic computer apparatuses, such as laptop computers, desktop computers, workstations, personal digital assistants, servers, blade servers, mainframe computers, and other suitable computers. The electronic apparatuses may also represent various forms of mobile apparatuses, such as personal digital processing, cellular telephones, smart phones, wearable apparatuses, and other similar computing apparatuses. The components shown herein, their connections and relationships, and their functions are merely as examples, and are not intended to limit the implementations of the disclosure described and/or claimed herein.

As shown in FIG. 8, the electronic apparatus 800 includes a computing unit 801, which may perform various appropriate actions and processing according to a computer program stored in a read-only memory (ROM) 802 or a computer program loaded into a random access memory (RAM) 803 from a storage unit 808. In the RAM 803, various programs and data required by the operation of the electronic apparatus 800 may also be stored. The computing unit 801, the ROM 802, and the RAM 803 are connected to each other through a bus 804. Input/output (I/O) interface 805 is also connected to the bus 804.

A plurality of components in the electronic apparatus 800 are connected to a I/O interface 805, including: an input unit 806, an output unit 807, a storage unit 808, and a communication unit 809. The input unit 806 may be any type of apparatus capable of inputting information to the electronic apparatus 800, the input unit 806 may receive input digital or character information and generate a key signal input related to user setting and/or function control of the electronic apparatus, and may include, but is not limited to, a mouse, a keyboard, a touch screen, a track pad, a trackball, a joystick, a microphone, and/or a remote control. The output unit 807 may be any type of apparatus capable of presenting information, and may include, but are not limited to, a display, a speaker, a video/audio output terminal, a vibrator, and/or a printer. The storage unit 808 may include, but is not limited to, a magnetic disk and an optical disk. The communication unit 809 allows the electronic apparatus 800 to exchange information/data with other apparatuses over a computer network, such as the Internet, and/or various telecommunication networks, and may include, but is not limited to, a modem, a network card, an infrared communication apparatus, a wireless communication transceiver and/or a chipset, such as a Bluetooth apparatus, a 802.11 apparatus, a WiFi apparatus, a WiMAX apparatus, a cellular communication apparatus, and/or the like.

The computing unit 801 may be a variety of general and/or special purpose processing components with processing and computing capabilities. Some examples of the computing unit 801 include, but are not limited to, a central processing unit (CPU), a graphics processing unit (GPU), various dedicated artificial intelligence (AI) computing chips, various computing units running machine learning model algorithms, a digital signal processor (DSP), and any suitable processor, controller, microcontroller, etc. The computing unit 801 performs the various methods and processes and/or processes described above. For example, in some embodiments, these methods and processes and/or processes may be implemented as a computer software program tangibly contained in a machine-readable medium, such as the storage unit 808. In some embodiments, part or all of the computer programs may be loaded and/or installed onto the electronic apparatus 800 via the ROM 802 and/or the communication unit 809. When the computer program is loaded into the RAM 803 and executed by the computing unit 801, one or more steps of the methods and processes and/or processes described above may be performed. Alternatively, in other embodiments, the computing unit 801 may be configured to perform these methods and processes and/or processes by any other suitable means (e.g., with the aid of firmware).

Various embodiments of the systems and techniques described above herein may be implemented in a digital electronic circuit system, an integrated circuit system, a field programmable gate array (FPGA), an application specific integrated circuit (ASIC), a dedicated standard product (ASSP), a system of system on a chip system (SoC), a complex programmable logic apparatus (CPLD), computer hardware, firmware, software, and/or combinations thereof. These various embodiments may include: implementation in one or more computer programs that may be executed and/or interpreted on a programmable system including at least one programmable processor, where the programmable processor may be a dedicated or universal programmable processor that may receive data and instructions from a storage system, at least one input apparatus, and at least one output apparatus, and transmit data and instructions to the storage system, the at least one input apparatus, and the at least one output apparatus.

The program code for implementing the method of the present disclosure may be written in any combination of one or more programming languages. These program code may be provided to a processor or controller of a general-purpose computer, a special purpose computer, or other programmable data processing apparatus such that the program code, when executed by the processor or controller, causes the functions/operations specified in the flowchart and/or block diagram to be implemented. The program code may be executed entirely on the machine, partly on the machine, partly on the machine as a stand-alone software package and partly on the remote machine or entirely on the remote machine or server.

In the context of the present disclosure, a machine-readable medium may be a tangible medium, which may contain or store a program for use by or in connection with an instruction execution system, apparatus, or apparatus. The machine-readable medium may be a machine-readable signal medium or a machine-readable storage medium. The machine-readable medium may include, but is not limited to, electronic, magnetic, optical, electromagnetic, infrared, or semiconductor systems, apparatus, or apparatuses, or any suitable combination of the foregoing. More specific examples of a machine-readable storage media may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage apparatus, a magnetic storage apparatus, or any suitable combination of the foregoing.

To provide interaction with a user, the systems and techniques described herein may be implemented on a computer having: a display apparatus (e.g., a CRT (cathode ray tube) or an LCD (liquid crystal display) monitor) for displaying information to a user; and a keyboard and pointing apparatus (e.g., a mouse or trackball) by which a user may provide input to the computer. Other types of apparatuses may also be used to provide interaction with a user; for example, the feedback provided to the user may be any form of perception feedback (e.g., visual feedback, auditory feedback, or tactile feedback); and the input from the user may be received in any form (including acoustic input, voice input, or haptic input).

The systems and techniques described herein may be implemented in a computing system including a back-end component (e.g., as a data server), or a computing system including a middleware component (e.g., an application server), or a computing system including a front-end component (e.g., a user computer with a graphical user interface or a web browser, the user may interact with implementations of the systems and techniques described herein through the graphical user interface or the web browser), or in a computing system including any combination of such back-end components, middleware components, or front-end components. The components of the system may be interconnected by digital data communication (e.g., a communications network) in any form or medium. Examples of communication networks include a local area network (LAN), a wide area network (WAN), the Internet, and a blockchain network.

The computer system may include a client and a server. Clients and servers are generally remote from each other and typically interact through a communication network. The relationship between clients and servers is generated by computer programs running on respective computers and having a client-server relationship to each other. The server may be a cloud server, or may be a server of a distributed system, or a server incorporating a blockchain.

It should be understood that the various forms of processes shown above may be used, and the steps may be reordered, added, or deleted. For example, the steps described in the present disclosure may be performed in parallel or sequentially or in a different order, as long as the results expected by the technical solutions disclosed in the present disclosure can be achieved, and no limitation is made herein.

Although embodiments or examples of the present disclosure have been described with reference to the accompanying drawings, it should be understood that the foregoing methods, systems, and apparatuses are merely embodiments or examples, and the scope of the present disclosure is not limited by these embodiments or examples, but is only defined by the authorized claims and their equivalents. Various elements in the embodiments or examples may be omitted or may be replaced by equivalent elements thereof. Further, the steps may be performed by a different order than described in this disclosure. Further, various elements in the embodiments or examples may be combined in various ways. Importantly, with the evolution of technologies, many elements described herein may be replaced by equivalent elements appearing after the present disclosure.

What is claimed is:

1. A training method for a deep learning model, wherein a first deep learning model comprises a plurality of first parameters, a second deep learning model comprises a plurality of second parameters, a number of the plurality of second parameters is less than a number of the plurality of first parameters, the plurality of first parameters includes a plurality of target parameters corresponding to the plurality of the second parameters, wherein the plurality of the second parameters are initialized to parameter values of the plurality of target parameters, the method comprises:
determining a target loss for both the first deep learning model and the second deep learning model;
adjusting parameter values of the plurality of first parameters and parameter values of the plurality of second parameters based on the target loss to obtain a trained first deep learning model and a trained second deep learning model, comprising:
in response to determining that the target loss indicates that the parameter values of at least part of the plurality of target parameters included in the first deep learning model need to be adjusted, synchronously adjusting parameter values of second parameters included in the second deep learning model corresponds to the at least part of the target parameters; and
in response to determining that the target loss indicates that the parameter values of at least part of the plurality of second parameters included in the second deep learning model need to be adjusted, synchronously adjusting parameter values of target parameters included in the first deep learning model corresponds to the at least part of the second parameters.

2. The method of claim 1, wherein determining the target loss for both the first deep learning model and the second deep learning model comprises:
determining a first loss of the first deep learning model for a first sample;
determining a second loss of the second deep learning model for a second sample; and
determining the target loss based on the first loss and the second loss.

3. The method of claim 2, wherein the first loss is the same as the second loss.

4. The method of claim 1, wherein the first deep learning model includes a first layer quantity of first layers, each first layer of the first layers includes a first intermediate dimension quantity of first intermediate dimensions,
the second deep learning model includes a second layer quantity of second layers, each second layer of the second layers includes a second intermediate dimension quantity of second intermediate dimensions, wherein the second layer quantity is less than the first layer quantity, and the second intermediate dimension quantity is less than the first intermediate dimension quantity,
the plurality of target parameters include first parameters in at least one target intermediate dimension of each target layer of at least one target layer, wherein the at least one target layer is obtained by selecting in the first layer quantity of first layers based on the second layer quantity, and the at least one target intermediate dimension is obtained by selecting in the first intermediate dimension quantity of first intermediate dimensions based on the second intermediate dimension quantity.

5. The method of claim 4, wherein the first deep learning model and the second deep learning model are based on a Transformer structure or a Transformer-like structure,
the first deep learning model includes a first hidden dimension quantity of first hidden dimensions, and each first layer of the first layers includes a first attention head quantity of first attention heads,
the second deep learning model includes a second hidden dimension quantity of second hidden dimensions, and each second layer of the second layers includes a second attention head quantity of second attention heads,
the plurality of target parameters include first parameters corresponding to a plurality of target hidden dimensions, and the plurality of target parameters include first parameters in at least one target attention head, wherein the plurality of target hidden dimensions is obtained by selecting in the first hidden dimension quantity of first hidden dimensions based on the second hidden dimension quantity, and the at least one target attention head is obtained by selecting in the first attention head quantity of first attention heads based on the second attention head quantity.

6. The method of claim 5, wherein the at least one target layer, the at least one target intermediate dimension, the plurality of target hidden dimensions, and/or the at least one target attention head are obtained by random selection.

7. The method of claim 1, wherein the first deep learning model is a pre-trained large model.

8. The method of claim 1, wherein both the first deep learning model and the second deep learning model are configured to perform at least one of the following tasks: a text processing task, an image processing task, and a speech processing task.

9. An inference method for a deep learning model, wherein a first deep learning model comprises a plurality of first parameters, a second deep learning model comprises a plurality of second parameters, a number of the plurality of second parameters is less than a number of the plurality of first parameters, the plurality of first parameters includes a plurality of target parameters corresponding to the plurality of the second parameters, wherein the plurality of the second parameters are initialized to parameter values of the plurality of target parameters, the first deep learning model and the second learning model are trained by performing training operations, the training operations comprises:
determining a target loss for both the first deep learning model and the second deep learning model;
adjusting parameter values of the plurality of first parameters and parameter values of the plurality of second parameters based on the target loss to obtain a trained first deep learning model and a trained second deep learning model, comprising:
in response to determining that the target loss indicates that the parameter values of at least part of the plurality of target parameters included in the first deep learning model need to be adjusted, synchronously adjusting parameter values of second parameters included in the second deep learning model corresponds to the at least part of the target parameters; and
in response to determining that the target loss indicates that the parameter values of at least part of the plurality of second parameters included in the second deep learning model need to be adjusted, synchronously adjusting parameter values of target parameters included in the first deep learning model corresponds to the at least part of the second parameters,
the inference method comprises:
generating a plurality of predicted tokens sequentially using the trained second deep learning model;
generating confidence level for each predicted token of the plurality of predicted tokens based on the plurality of predicted tokens using the trained first deep learning model; and
verifying the plurality of predicted tokens based on a generation sequence of the plurality of predicted tokens to obtain an inference result, comprising:
in response to determining that the confidence level of a currently verified predicted token is lower than a preset threshold, generating a correction token at a position of the currently verified predicted token using the trained first deep learning model to replace the currently verified predicted token as a verified predicted token;
in response to determining that a preset token generation condition is satisfied, regenerating predicted tokens sequentially from a next position of the correction token based on the correction token using the trained second deep learning model and generating a confidence level for each regenerated predicted token of the regenerated predicted tokens using the trained first deep learning model for verification; and
obtaining the inference result based on the verified predicted tokens.

10. The method of claim 9, wherein the verifying the plurality of predicted tokens comprises:
in response to determining that the confidence level of the currently verified predicted token is not less than the preset threshold, retaining the predicted token as a verified predicted token.

11. The method of claim 9, wherein the preset token generation condition includes that the number of generated tokens is less than a preset number.

12. The method of claim 9, wherein the preset token generation condition includes the correction token indicating that token generation has not ended.

13. A electronic device, comprising:
one or more processors;
a memory storing one or more programs configured to be executed by the one or more processors, the one or more programs including instructions for:
a deep learning model, wherein a first deep learning model comprises a plurality of first parameters, a second deep learning model comprises a plurality of second parameters, a number of the plurality of second parameters is less than a number of the plurality of first parameters, the plurality of first parameters includes a plurality of target parameters corresponding to the plurality of the second parameters, wherein the plurality of the second parameters are initialized to parameter values of the plurality of target parameters;
determining a target loss for both the first deep learning model and the second deep learning model;
adjusting parameter values of the plurality of first parameters and parameters values of the plurality of second parameters based on the target loss to obtain a trained first deep learning model and a trained second deep learning model, comprising:
in response to determining that the target loss indicates that the parameter values of at least part of the plurality of target parameters included in the first deep learning model need to be adjusted, synchronously adjusting parameter values of second parameters included in the second deep learning model corresponds to the at least part of the target parameters; and
in response to determining that the target loss indicates that the parameter values of at least part of the plurality of second parameters included in the second deep learning model need to be adjusted, synchronously adjust parameter values of target parameters included in the first deep learning model corresponds to the at least part of the second parameters.

14. The electronic device of claim 13, wherein determining the target loss for both the first deep learning model and the second deep learning model comprises:
determining a first loss of the first deep learning model for a first sample;
determining a second loss of the second deep learning model for a second sample; and
determining the target loss based on the first loss and the second loss.

15. The electronic device of claim 14, wherein the first sample is the same as the second sample.

16. The electronic device of claim 13, wherein the first deep learning model includes a first layer quantity of first layers, each first layer of the first layers includes a first intermediate dimension quantity of first intermediate dimensions,
the second deep learning model includes a second layer quantity of second layers, each second layer of the second layers includes a second intermediate dimension quantity of second intermediate dimensions, wherein the second layer quantity is less than the first layer quantity, and the second intermediate dimension quantity is less than the first intermediate dimension quantity,
the plurality of target parameters include first parameters in at least one target intermediate dimension of each target layer of at least one target layer, wherein the at least one target layer is obtained by selecting in the first layer quantity of first layers based on the second layer quantity, and the at least one target intermediate dimension is obtained by selecting in the first intermediate dimension quantity of first intermediate dimensions based on the second intermediate dimension quantity.

17. The electronic device of claim 16, wherein the first deep learning model and the second deep learning model are based on a Transformer structure or a Transformer-like structure,
the first deep learning model includes a first hidden dimension quantity of first hidden dimensions, and each first layer of the first layers includes a first attention head quantity of first attention heads,
the second deep learning model includes a second hidden dimension quantity of second hidden dimensions, and each second layer of the second layers includes a second attention head quantity of second attention heads,
the plurality of target parameters include first parameters corresponding to a plurality of target hidden dimensions, and the plurality of target parameters include first parameters in at least one target attention head, wherein the plurality of target hidden dimensions are obtained by selecting in the first hidden dimension quantity of first hidden dimensions based on the second hidden dimension quantity, and the at least one target attention head is obtained by selecting in the first attention head quantity of first attention heads based on the second attention head quantity.

18. The electronic device of claim 17, wherein the at least one target layer, the at least one target intermediate dimension, the plurality of target hidden dimensions, and/or the at least one target attention head are obtained by random selection.

19. The electronic device of claim 13, wherein the first deep learning model is a pre-trained large model.

20. The electronic device of claim 13, wherein both the first deep learning model and the second deep learning model are configured to perform at least one of the following tasks: a text processing task, an image processing task, and a speech processing task.
